(19) United States
(12) Patent Application Publication
(10) Pub. No.: US 2006/0257235 A1
(43) Pub. Date: Nov. 16, 2006

(54) Polybag stabilizer

(75) Inventor: N. Kyle Shiplett, Moore, OK (US)

Correspondence Address: CARGILL, INCORPORATED, LAW/24, 15407 MCGINTY ROAD WEST, WAYZATA, MN, 55391, US

(73) Assignee: Cargill, Inc.

(21) Appl. No.: 11/083,336

(22) Filed: Mar. 18, 2005

(51) Int. Cl. B65G 57/00

(52) U.S. Cl. 414/788

(57) ABSTRACT

A stabilizer for stabilizing a stack of bags held in a magazine. The stabilizer includes a first panel, a second panel and an adjustable positioning device. A portion of the second panel is configured to curve away at an angle from the bottom surface of the first panel. The adjustable positioning device adjusts the angle of the second panel.

### BACKGROUND

The present invention relates generally to a device for controlling the feeding of articles, such as bags and the like, from magazines for feeding and filling machines.

Generally, machines are used to hold and fill bags with animal feed and other articles, such as those described in U.S. Pat. Nos. 2,753,097, 4,345,629 and 4,537,015 (hereby incorporated by reference herein in its entirety). Conventionally, bags are stacked in a magazine or enclosure. The bottom or lower bag is generally removed from the stack by a mechanical device of the machine and moved to a filling station.

A drawback of such conventional machines is that the bags tend to bend in the middle causing difficulty in removing the appropriate bag from the magazine. Occasionally, the bags can become misaligned and prevent the holding and filling machine from working appropriately.

### SUMMARY

According to an embodiment of the present invention, a stabilizer for a plurality of bags in a stack is provided. The stabilizer includes a first panel and a second panel attached to the first panel, and an adjustable positioning device connected to the first panel and second panel. A portion of the second panel is configured to bend away from the bottom surface of the first panel. The adjustable positioning device is configured to adjust the amount of bend of the second panel.

According to another embodiment of the present invention, a device for holding a plurality of bags in a stack for sequential feed from an end of the stack is provided. The device includes a enclosure with an open top and a bottom and a stabilizer. The stabilizer includes a first panel with a top surface and a bottom surface, a second panel with a top surface and a bottom surface, the second panel attached to the first panel, and an adjustable positioning device connected to the first panel and second panel. A portion of the second panel is configured to curve away at an angle from the bottom surface of the first panel. The adjustable positioning device is configured to adjust the angle of the second panel.

According to another embodiment of the present invention, a machine for holding and filling a stack of bags is provided. The machine includes an enclosure for holding a stack of bags, a gripper mechanism configured to remove a bag from the stack in the enclosure, and a stabilizer. The stabilizer includes a first panel with a top surface and a bottom surface, a second panel with a top surface and a bottom surface, the second panel attached to the first panel, and an adjustable positioning device connected to the first panel and second panel. A portion of the second panel is configured to curve away at an angle from the bottom surface of the first panel. The adjustable positioning device is configured to adjust the angle of the second panel.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a side view of a stabilizer according to an embodiment of the present invention.

FIGS. 2a and 2b are top plan views; FIG. 2a is a top plan view of a first panel of the stabilizer according to FIG. 1, and FIG. 2b is a top plan view of a second panel of the stabilizer according to FIG. 1.

FIG. 3 is a side view of an adjustable positioning device.

FIG. 4 is a perspective view of an enclosure for holding a plurality of bags according to an embodiment of the present invention.

FIG. 5 is a perspective view of a machine for holding and filling bags taken along line A-A of FIG. 4 according to an embodiment of the present invention.

### DETAILED DESCRIPTION

Hereinafter, embodiments of the present invention will be described with reference to the attached drawings.

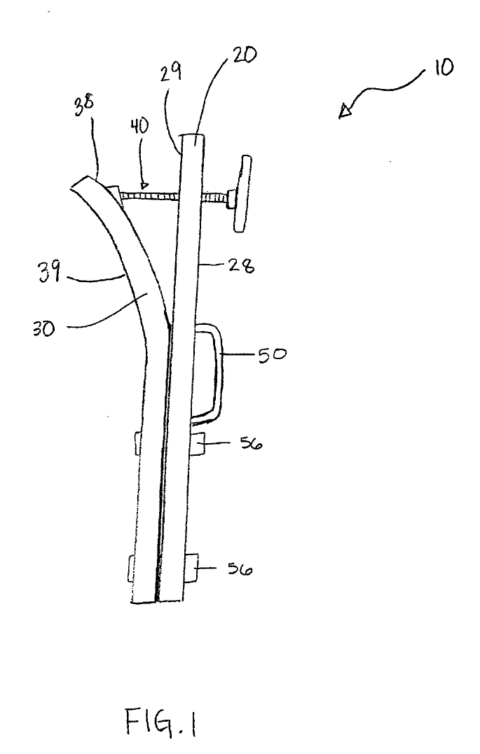

FIGS. 1-3 show an apparatus, referred to as a stabilizer 10, for bags or other articles. The stabilizer 10 shown in, for example, FIG. 1, includes a first panel 20, a second panel 30 and an adjustable positioning device 40.

The stabilizer 10 is configured to stabilize a plurality of bags 58, such as poly bags, that are arranged in a stack. The stack of bags 58 are held in an enclosure or magazine 60, or similar type of holder. The stabilizer 10 is positioned on top of the stack of bags 58 in order to smooth out the bags 58 and help maintain the proper position of the bags 58. The stabilizer 10 can also be used to stabilize other articles, such as cards, paper, etc.

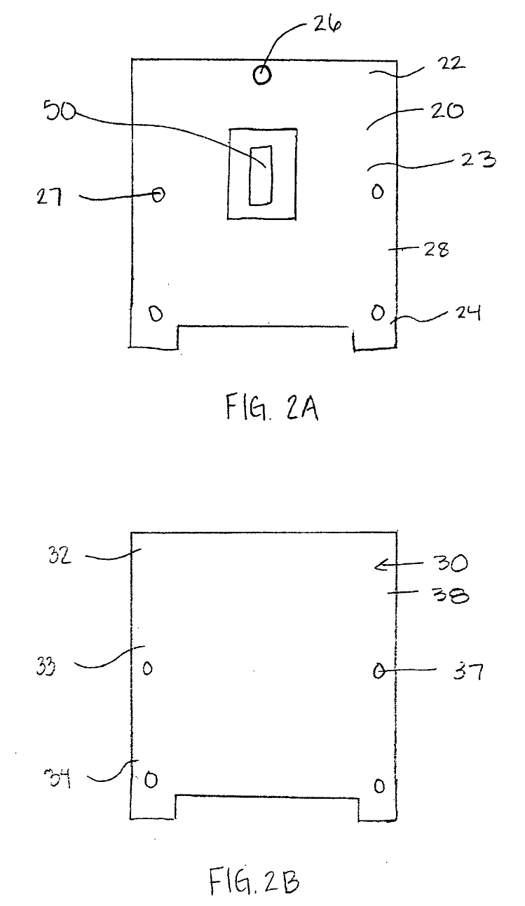

As can be seen in FIG. 2a, the first panel 20 has a top 28 and a bottom 29 side and an upper portion 22, middle portion 23 and a lower portion 24. A handle 50 is attached to the top side 28 of the first panel 20. The handle 50 allows a user to more easily maneuver the stabilizer in a magazine 60 or machine 70.

The first panel 20 includes an opening 26 for receiving the adjustable positioning device 40. The opening 26 is positioned generally along the upper portion 22 of the first panel 20. Bolt holes 27 are also positioned in the first panel 20 in the middle 23 and lower 24 portions. The bolt holes 27 are for receiving and attaching bolts 56 to connect the first panel 20 with the second panel 30. The first panel 20 is substantially flat.

The second panel 30, as can be seen in FIG. 2b, has a top 38 and a bottom 39 side and an upper portion 32, middle portion 33 and a lower portion 34. Bolt holes 37 are positioned in the second panel 30 in the middle 33 and lower 34 portions. The bolt holes 27 are similar to bolt holes 27 and, with bolts 56, attach the first panel 20 to the second panel 30. The bolt holes 37 are generally not positioned in the upper portion 32 of the second panel 30 because the second panel 30 is configured to bend or curve away from the first panel 20 when attached. The second panel 30 curves away from the first panel 20 at approximately the middle 33 portion or just above the middle portion and above this point, the first panel 20 and second panel are not connected by bolts or other connection devices.

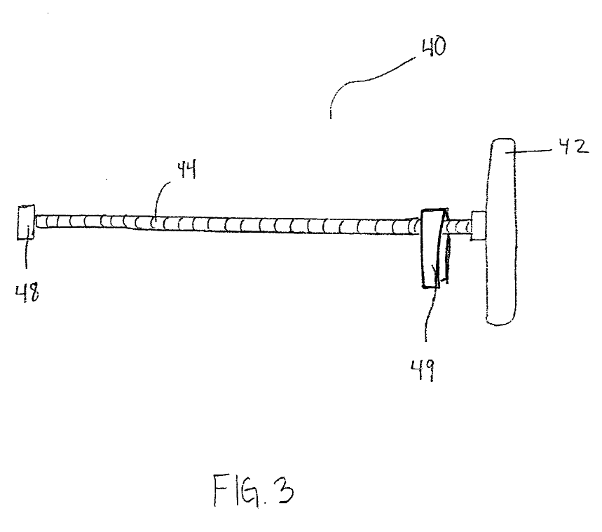

The second panel 30 curves away or separates from the first panel 20 by the adjustable positioning device 40, which is shown in FIG. 3. The adjustable positioning device 40 includes a threaded bolt or screw 44 and a handle 42 attached to the screw 44 at an end. The handle 42 may be circular and employed as a dial for measuring the amount of corresponding bend in the second panel. The screw 44 is threadably connected to the first panel 20 at the opening 26 and is affixed to the second panel 30 at a connecting block 48. When the dial 42 is turned in a first direction, the screw 44 is threaded further through the opening 26, thus increasing the separation angle or distance of the second panel 30 away from the first panel 20. When the dial 42 is turned in a second direction, the screw 44 is threaded back in an opposite direction through the opening 26, thus decreasing the separation angle of the second panel 30 away from the first panel 20. Additionally, the adjustable positioning device 40 can include a clamp or lock 49. The lock 49 is secured over the screw 44 between the top surface 28 of the first panel 20 and the dial 42. The lock 49 prevents the screw 44 from prematurely unthreading or threading.

The dial 42, with the lock 49 removed, allows a user to determine the amount of pressure and angle on the stack of bags 58. This allows the user to put pressure on the bags 58 at the point where the bags 58 tend to slide. The angle of the second panel 30 can be varied depending on the thickness, weight and type of bags 58 the stabilizer is on.

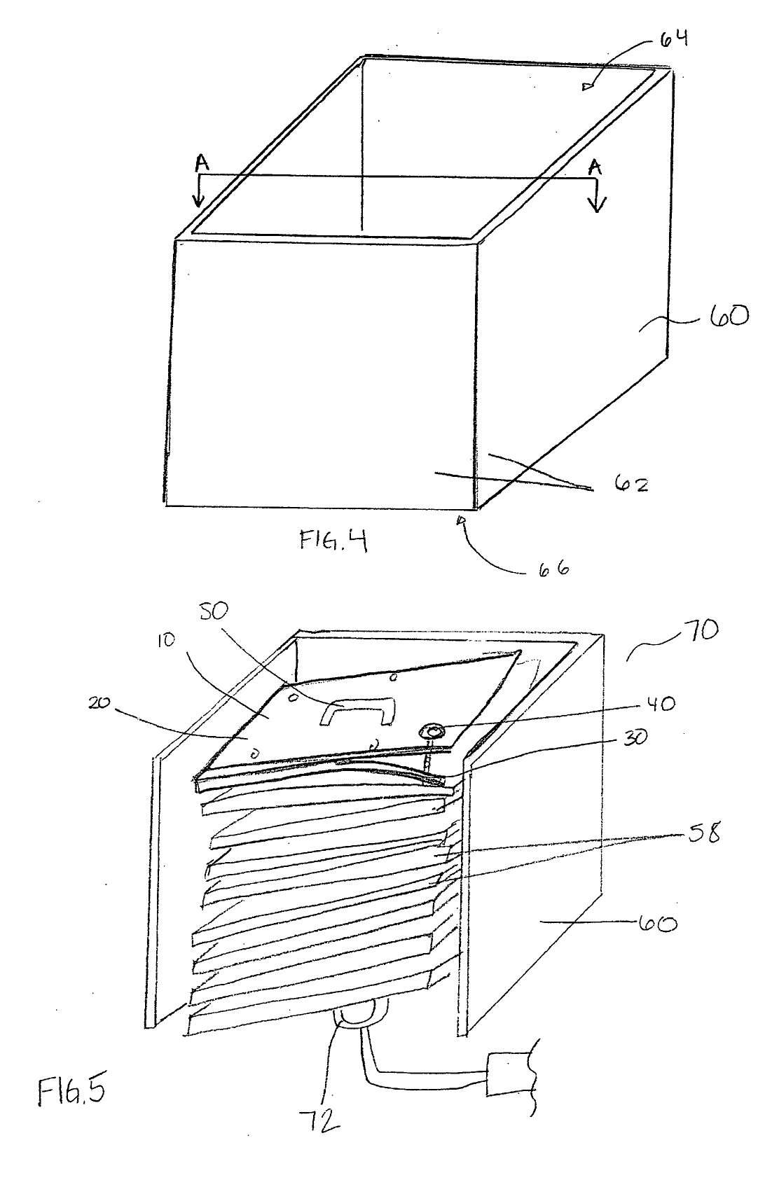

FIGS. 4 and 5 show a magazine 60 for use in a machine 70 for holding and filling bags 58. The bags 58 can be filled with animal feed or any other appropriate article. The magazine 60 is generally a box-like shape with side walls 62 and an open top 64 and bottom 66. The walls 62 of the magazine hold the bags 58 that lay in a stack or pile. The bags 58 can lay at an angle, such as 30°, or any other suitable angle. The stabilizer 10 is positioned on the top of the stack of bags 58 (near the top 64 of the magazine). A gripper mechanism 72 grips the lowest bag 58 and moves this bag 58 into position for filling. The gripper mechanism 72 and machine 70 are shown only partially as an example, and may take any other form.

The stabilizer 10 sits on the stack of bags 58, with the upper portion 22 of the first panel 20 and upper portion 32 of the second panel 30 positioned higher than the lower portions 22, 32 of the first 20 and second 30 panels.

The first panel 20 and second panel 30 are generally rectangular in shape. The first 20 and second 30 panels can be any suitable shape or weight, preferably of a size and shape to cover a bag 58 and fit inside the magazine 60. The first panel 20 is preferentially formed of wood, such as plywood, or any other suitable material. The second panel 30 is preferentially formed of a flexible material such as, for example, an ultra high molecular weight (UHMW) rhinohide material. The bottom surface of the second panel 30 should be relatively smooth in order to reduce friction with the underlying stack of bags. Thus, the second panel 30 panels can also include a coating on the bottom 39. The coating can be a polyurethane, or any other suitable coating. Further, the shape and size of the first panel 20 can differ from the second panel 30.

The stabilizer should be heavy enough to stabilize the underlying stack of bags. For example, the stabilizer 10 can have a weight of approximately 35 pounds. However, the stabilizer 10 can have any weight suitable for stabilizing bags 58 or any other article in use.

It will be recognized that there are other ways of implementing the invention. Further, any combination of the embodiments can be used.

While the invention is described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention. Furthermore, any combination of embodiments may be used. All references and publications cited herein are incorporated by reference in their entireties.

What is claimed is:

1. A stabilizer for a plurality of bags in a stack, comprising:
a first panel with a top surface and a bottom surface;
a second panel attached to the first panel and including a top surface and a bottom surface, wherein a portion of the second panel is configured to bend away from the bottom surface of the first panel, and
a positioning device connected to the first panel for adjusting the amount of bend in the second panel.

2. The stabilizer according to claim 1, wherein the first panel is substantially flat.

3. The stabilizer according to claim 1, wherein the first panel and second panel are attached by an attachment mechanism at a lower half of the first panel and second panel.

4. The stabilizer according to claim 1, wherein a lower portion of the bottom surface of the first panel abuts a lower portion of the top surface of the second panel.

5. The stabilizer according to claim 1, further comprising a handle mounted to the top surface of the first panel.

6. The stabilizer according to claim 1, wherein the adjustable positioning device includes a threaded bolt for forcing a portion of the second panel to bend away from the first panel.

7. The stabilizer according to claim 6, wherein the adjustable positioning device includes a handle for turning the bolt.

8. The stabilizer according to claim 1, further comprising a polyurethane coating on the bottom surface of the second panel.

9. The stabilizer according to claim 1, further comprising a polyurethane coating on the bottom surface of the second panel.

10. The stabilizer according to claim 1, wherein the second panel comprises an ultra high molecular weight rhinohide material.

11. The stabilizer according to claim 1, further comprising a lock removably attached to the adjustable positioning device.

12. A device for holding a plurality of bags in a stack for sequential feed from an end of the stack, comprising:
an enclosure for holding the stack of bags, wherein the enclosure has an open top and an open bottom; and
a stabilizer including:
a first panel with a top surface and a bottom surface;
a second panel connected to the first panel and including a top surface and a bottom surface; and
an adjustable positioning device connected to the first panel,
wherein a portion of the second panel is configured to bend away from the bottom surface of the first panel, and
wherein the adjustable positioning device is configured to adjust the amount of bend of the second panel.

13. The device according to claim 12, wherein the stabilizer is positioned on top of the stack of bags in the enclosure.

14. The device according to claim 13, wherein the stabilizer is positioned on the stack of bags at an angle with the adjustable positioning device positioned at an upper portion of the stabilizer.

15. The device according to claim 14, wherein the second panel is adjacent the stack of bags.

16. A machine for holding and filling a stack of bags, comprising:
an enclosure for holding a stack of bags;
a gripper mechanism configured to remove a bag from the stack in the enclosure; and
a stabilizer including:
a first panel with a top surface and a bottom surface;
a second panel with a top surface and a bottom surface, the second panel attached to the first panel; and
an adjustable positioning device connected to the first panel and second panel,
wherein a portion of the second panel is configured to bend away from the bottom surface of the first panel, and
wherein the adjustable positioning device is configured to adjust the angle of the second panel.
